(19) United States
(12) Patent Application Publication
(10) Pub. No.: US 2024/0307841 A1
(43) Pub. Date: Sep. 19, 2024

(54) CHEMICAL PROCESSING VESSELS HAVING PLATE GRID DISTRIBUTORS AND METHODS OF OPERATING THE SAME

(71) Applicant: Dow Global Technologies LLC, Midland, MI (US)

(72) Inventors: Matthew T. Pretz, Freeport, TX (US); Donald F. Shaw, Forked River, NJ (US); Richard E. Walter, Long Valley, NJ (US); Albert Meza, Houston, TX (US); Fermin Sandoval, Houston, TX (US); Liwei Li, Freeport, TX (US)

(73) Assignee: Dow Global Technologies LLC, Midland, MI (US)

(21) Appl. No.: 18/573,195

(22) PCT Filed: Jun. 24, 2022
(86) PCT No.: PCT/US2022/034844

§ 371 Date: Dec. 21, 2023

Related U.S. Application Data
(60) Provisional application No. 63/216,786, filed on Jun. 30, 2021.

(51) Int. Cl. B01J 8/44; B01J 8/18

(52) U.S. Cl. CPC B01J 8/44; B01J 8/1881; B01J 2208/00884; B01J 2208/00902; B01J 2208/00938

(57) ABSTRACT

According to one or more embodiments, a chemical processing vessel may include side walls, a floor, a catalyst outlet through the floor, and a plate grid distributor for distributing a fluid. The plate may include a plurality of apertures extending through the thickness of the plate and a central opening. The plate may include a catalyst transport passage extending from the central opening to the catalyst outlet. The catalyst transport passage may have a greater cross section area at the central opening of the plate than at the catalyst outlet. According to one or more embodiments, a method of operating a chemical processing vessel passing a fluid into the chemical processing vessel, directing the fluid through a plate grid distributor, and passing catalyst from above the plate, through the catalyst transport passage, and out of the chemical processing vessel through the catalyst outlet.

### CROSS-REFERENCE TO RELATED APPLICATIONS

The present application is a PCT application claiming priority to U.S. Provisional Patent Application No. 63/216,786, filed Jun. 30, 2021. and entitled “CHEMICAL PROCESSING VESSELS HAVING PLATE GRID DISTRIBUTORS AND METHODS OF OPERATING THE SAME.” the contents of which are incorporated in their entirety herein.

### BACKGROUND

### Field

The present specification generally relates chemical processing and, more specifically. to systems and methods for distributing a fluid through a distributor.

### Technical Background

Gaseous chemicals may be fed into reactors or other vessels through distributors. Distributors may be utilized to promote balanced distribution of a fluid into such reactors or vessels. Such distribution of fluid may promote preferred reactions and may maintain mass transport equilibriums in chemical systems.

### SUMMARY

In a number of chemical processes, fluids are fed through plate grid distributors into chemical processing vessels, such as reactors or other vessels. In some chemical processes. catalyst may be simultaneously removed while fluids are fed into the chemical processing vessels. For example, such processes may take place in catalyst processing portions of reactor systems. such as oxygen soak zones. Conventional plate grid distributors may require a hopper cone above the plate of the plate grid distributor. Any catalyst above the plate and below the hopper cone may be unnecessary and useless to a degree. Further, conventional plate grid distributors may require expansion joints. These conventional plate grid distributors may increase the necessary catalyst inventory and/or make removal of catalyst from the chemical processing vessels difficult. Accordingly, there is an on-going need for improved plate grid distributors. It has been found that plate grid distributors with a catalyst transport passage, as described herein, may reduce the amount of catalyst required and/or provide an efficient means for removal of catalyst from chemical processing vessels. Embodiments of such plate grid distributors are described herein. Embodiments of the present disclosure meet this need by utilizing catalyst transport passages that are able to align the top of the standpipe (i.e., the catalyst transport passage) with the upper surface of the plate that also avoid the need for a hopper cone.

According to one embodiment, a chemical processing vessel may include side walls, a floor, a catalyst outlet through the floor, and a plate grid distributor for distributing a fluid in the chemical processing vessel. The plate grid distributor may include a plate having an upper surface and a lower surface opposite the upper surface defining a thickness of the plate. The plate may include a plurality of apertures extending through the thickness of the plate. The plate may include a central opening. A catalyst transport passage may extend from the central opening to the catalyst outlet forming a passage from an area above the plate to the catalyst outlet. The catalyst transport passage and the plate may be connected such that they form a unitary body. The catalyst transport passage may have a greater cross section area at the central opening of the plate than at the catalyst outlet to enable gas bubbles to disengage from the flowing catalyst.

According to another embodiment, a method of operating a chemical processing vessel may include passing a fluid into the chemical processing vessel at reaction conditions through a gaseous feed conduit below the plate grid distributor and directing the fluid through a plate grid distributor in the chemical processing vessel. The plate grid distributor may include a plate comprising an upper surface and a lower surface opposite the upper surface defining a thickness of the plate. The plate may include a plurality of apertures extending through the thickness of the plate. The plate may include a central opening. A catalyst transport passage may extend from the central opening to the catalyst outlet forming a passage from an area above the plate to the catalyst outlet. The catalyst transport passage and the plate may be connected such that they form a unitary body. The catalyst transport passage may have a greater cross section area at the central opening of the plate than at the catalyst outlet. The method may include passing catalyst from above the plate. through the catalyst transport passage, and out of the chemical processing vessel through the catalyst outlet.

Additional features and advantages will be set forth in the detailed description which follows, and in part will be readily apparent to those skilled in the art from that description or recognized by practicing the embodiments described herein, including the detailed description which follows and the claims.

It is to be understood that both the foregoing general description and the following detailed description describe various embodiments and are intended to provide an overview or framework for understanding the nature and character of the claimed subject matter.

### BRIEF DESCRIPTION OF THE DRAWINGS

FIG. 1 is a schematic illustration of a cross-sectional view of a vessel and plate grid distributor. in accordance with one or more embodiments of the present disclosure;

FIG. 2 is a schematic illustration of a perspective view of a plate grid distributor and catalyst transport passage, in accordance with one or more embodiments of the present disclosure;

FIG. 3 is a schematic illustration of a reactor system, in accordance with one or more embodiments of the present disclosure;

FIG. 4A is a schematic illustration of a sparger, in accordance with one or more embodiments of the present disclosure; and

FIG. 4B is a schematic illustration of a cross-sectional view of the sparger of FIG. 4A. according to one or more embodiments of the present disclosure.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

The present disclosure is directed, according to one or more embodiments described herein, towards chemical processing vessels comprising plate grid distributors and methods of operating chemical processing vessels. Generally. the plate grid distributors described herein may comprise a plate and a catalyst transport passage. The plate grid distributors described herein may be used for distributing a fluid in a chemical processing vessel. Generally, the plate grid distributors described herein comprise a catalyst transport passage that may help remove catalyst from the chemical processing vessel. The catalyst transport passages of the present disclosure may minimize catalyst inventory, may remove catalyst from the center of a fluidized bed, and may provide additional annular space around the plate grid distributor.

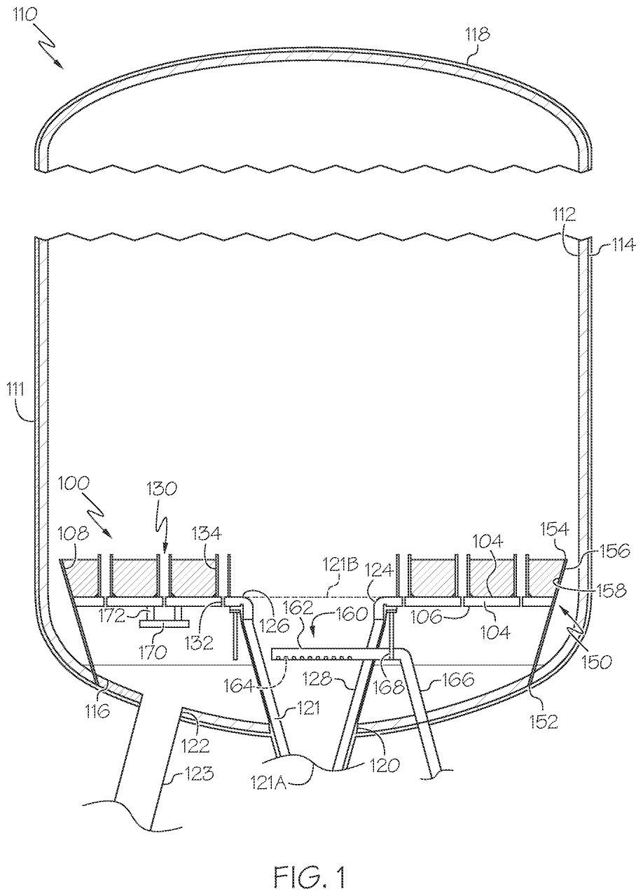

Referring now to FIG. 1. the plate grid distributors 100 of the present disclosure may be positioned in a chemical processing vessel 110. The chemical processing vessel 110 may have various configurations. The chemical processing vessel 110 may include one or more polyhedron. sphere. cylinder, cone, irregular shape, combinations thereof, and/or portions thereof. For example, the chemical processing vessel 110 may include a right hollow cylinder with a longitudinal axis. The chemical processing vessel 110 may include side walls 111. a floor 116, a top 118, a catalyst outlet 120, and a gaseous feed conduit receiving passageway 122. The side walls 111. the floor 116, and the top 118 of the chemical processing vessel 110 may include a refractory-lined inner wall 112 and an outer wall 114.

According to one or more embodiments, the plate grid distributor 100 for distributing a fluid in a chemical processing vessel 110 may comprise a plate 102. The plate 102 may comprise an upper surface 104 and a bottom surface 106. The bottom surface 106 may be opposite the upper surface 104 and spaced apart from the upper surface 104. The distance between the upper surface 104 and the bottom surface 106 may define a thickness of the plate 102. The plate 102 may comprise an outer surface 108. The outer surface 108 may have a portion that is normal to the upper surface 104 and the bottom surface 106. The outer surface 108 can be welded to the upper surface 104. The plate 102 may have an average diameter from greater than or equal to 5 feet (1.5 meters (m)) to less than or equal to 75 feet (22.9 m), such as from greater than or equal to 10 feet (3.0 m) to less than or equal to 50 feet (15.2 m). The plate 102 may be substantially planar (i.e., the upper surface 104 and the bottom surface 106 may be substantially parallel). In other embodiments, the plate 102 may be dished (i.e., non-planar). When the plate 102 is dished the upper surface 104 and the bottom surface 106 may not be planar (i.e., the outer surface 108 of the plate 102 may be higher than the upper surface 104 or lower or the bottom surface 106).

The bottom surface 106, the upper surface 104, or both of the plate 102 may be refractory-lined. For example, FIG. 1 shows refractory material in cross hatched area above the plate 102. Additionally or alternatively, other materials with insulating properties (e.g., insulating material) may be disposed between the bottom surface 106 and the upper surface 104 of the plate 102. The refractory lining, the insulating material, or both may help prevent the bottom surface 106 of the plate 102 from heating.

The plate 102 may comprise a plurality of apertures 130. Each of the plurality of apertures 130 may be in fluid communication with the bottom surface 106 of the plate 102 and the upper surface 104 of the plate 102 via first apertures 132 and second apertures 134. The plurality of apertures 130 may be even with the upper surface 104 and/or the bottom surface 106. Alternatively, the plurality of apertures 130 may extend past (i.e., below) the bottom surface 106 and/or past (i.e., above) the upper surface 104. That is, the plurality of apertures 130 may include shrouds extending above the upper surface 104 of the plate 102. The second apertures 134 may have a greater cross-sectional area than the first apertures 132.

The first apertures 132 of the plate 102 may provide a pressure drop from the bottom surface 106 of the plate 102 to the upper surface 104 of the plate 102 to ensure an even distribution of gasses passing through the plate 102. The second apertures 134 may reduce the velocity of the gasses passing through the plate 102. If the gasses passing through the plate 102 are at too high of a velocity, the gasses may attrite or damage catalyst in the chemical processing vessel 110 above the plate 102. The first apertures 132 and the second apertures 134 of the plate 102 may have uniform or varying cross-sectional areas to help provide that an even distribution of gas passes through each of the plurality of apertures 130. For instance, apertures 130 that are nearer to gaseous feed conduit 132 may have a greater pressure difference between the bottom surface 106 and the upper surface 104 of the plate 102. As such, first apertures 132 of the plate 102 that are nearer to the gaseous feed conduit 123 can have a smaller cross-sectional area than first apertures 132 that are further from the gaseous feed conduit 123 to help equilibrate a pressure differential across the plate 102.

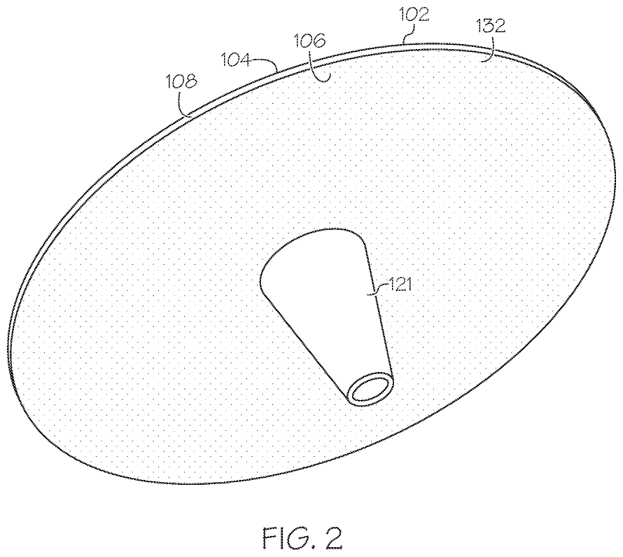

As shown in FIG. 2, the plate 102 may include a bottom surface 106 and outer surface 108. The bottom surface 106 can include a plurality of apertures 130. formed by first apertures 132 of the plate 102. The plurality of apertures 130 may be arranged around the central opening 121B in a geometric pattern. The geometric pattern may be different for various applications. For example, the plurality of apertures 130 may be arranged around the central opening 121B in a grid and/or concentrically. The plate 102 can include 10 to 50 apertures 130 per square meter, such as between 20 to 35 apertures per square meter. Other numbers of apertures 130 per square meter are also contemplated.

Referring again to FIG. 1, a ratio of an inside diameter of the first apertures 132 of the plate 102 to an inside diameter of the second apertures 134 of the plate 102 may be from 0.13 to 0.8, such as from 0.34 to 0.51. A ratio of the inside diameter of the first apertures 132 of the plate 102 to the inside diameter of the chemical processing vessel 110 may be from 0.003 to 0.014, such as from 0.008 to 0.012. A ratio of the inside diameter of the second apertures 134 of the plate 102 to the inside diameter of the chemical processing vessel 110 may be from 0.008 to 0.163, such as from 0.026 to 0.087.

The plate grid distributor 100 may comprise an outer support 150. The outer support 150 may mount and support the plate 102 to the chemical processing vessel 110 at or near the floor 116 of the chemical processing chemical processing vessel 110. The outer support 150 may extend downward at or near an outer periphery of the plate 102. As used in the present disclosure, “an outer periphery of the plate” may refer to the outermost (i.e., portion closest to the refractory-lined inner wall) 25% of the plate 102. The outer support 150 may include a first end 152 and a second end 154. The first end 152 may connected to the floor 116 of the chemical processing vessel 110. The second end 154 may be connected the plate 102. The first end 152 and the second end 154 may be spaced apart from one another. The space between the first end 152 and the second end 154 may define an outer planar surface 156. The outer planar surface 156 may be spaced apart from an inner planar surface 158. The outer planar surface 156 may be spaced apart from the refractory-lined inner wall 112. The outer planar surface 156 may be connected to a portion of the inner planar surface 158 proximate to the second end 154 and apart from the first end 152. In embodiments, plate grid distributor packing (i.e., insulation) may be disposed between a lower portion of refractory-lined inner wall 112 that is nearer to where the refractory-lined inner wall 112 connects to the floor 116 of the chemical processing vessel 110 and the outer surface 108 of the plate 102. The plate grid distributor packing may be ceramic wool insulation. In embodiments. the outer support 150 may be angled. Alternatively, the outer support 150 may be vertical (i.e., perpendicular to the floor 116 or parallel to the side walls 111).

Referring again to FIG. 1. the chemical processing vessel 110 may include a gaseous feed conduit 123. The gaseous feed conduit 123 may be connected to a gaseous feed conduit receiving passageway 122 that extends through the floor of the chemical processing vessel 110. The chemical processing vessel 110 may include a plurality of gaseous feed conduits 123. In embodiments, the plurality of gaseous feed conduits 123 may be connected to a plurality of gaseous feed conduit receiving passageways 122. The plurality of gaseous feed conduit receiving passageways 122 may encircle the longitudinal axis of the chemical processing vessel 110.

The gaseous feed conduit 123 may be mounted flush with the refractory-lined inner wall 112 or can extend beyond the refractory-lined inner wall 112. A ratio of an inside diameter of the gaseous feed conduit 112 to an inside diameter of the chemical processing vessel 110 may be from 0.02 to 0.4, such as from 0.20 to 0.23.

The plate grid distributor 100 may include a deflector plate 170 spaced apart from, and operatively connected to, a portion of the bottom surface 106 of the plate 102 by a plurality of deflector plate connectors 172. The deflector plate 170 may deflect and/or reduce a velocity of the gaseous feed entering the chemical processing vessel 110. The deflection and/or redirection in velocity may cause the gaseous feed to be more evenly distributed through the plurality of apertures 130.

Still referring to FIG. 1 and as previously discussed in the present application, the chemical processing vessel 110 may include the catalyst transport passage 121. In embodiments, the catalyst transport passage 121 may comprise a conical frustum. As used in the present disclosure, a “conical frustum” may refer to a frustum shape created by cutting the top off a cone (with the cut being made parallel to the base). The catalyst transport passage 121 may extend from the central opening 121B to the catalyst outlet 120. The catalyst transport passage 121 may form a passage from an area above the plate 102 to the catalyst outlet 120. The catalyst transport passage 121 and the plate 102 may be connected such that they form a unitary body. As used herein, a unitary body may mean that two components (e.g., the catalyst transport passage 121 and the plate 102) are formed from a single structure. Without being bound to any particular theory, it is believed that a unitary body may be lighter and more rigid than a construction using separate pieces. The plate 102 and catalyst transport passage 121 may be operable to contain catalyst below the plate 102 inside the catalyst transport passage 121. It should be understood that catalyst may also be above the plate 102 as well as within the catalyst transport passage 121. The catalyst transport passage 121 may comprise a rounded transition 124 between the catalyst transport passage 121 and the plate 102. A “rounded transition” may refer to a rounding of an interior or exterior corner of a part design. Rounded geometry, when on an interior corner is a line of concave function, whereas a rounded geometry on an exterior corner is a line of convex function. The fillet transition 124 may provide a smooth transition from the plate 102 to the catalyst transport passage 121. A refractory material may be in direct contact with and may cover substantially all of an inner surface 126 of the catalyst transport passage 121.

The catalyst transport passage 121 may not extend above the plate 102. The fillet transition 124 of the catalyst transport passage 121 may provide a flush transition from the catalyst transport passage 121 to the plate 102. That is, an upper surface 128 of the catalyst transport passage 121 may be substantially planar with the upper surface 104 of the plate 102. Such a design may minimize the catalyst inventory needed in chemical processes being performed in the chemical processing vessel 110. Conventional plate grid distributors and catalyst withdrawal standpipes may require a hopper cone above the conventional plate grid distributor. Any particulate solids above the plate of the conventional plate grid distributor and in the hopper cone are, in some embodiments, not useful and may increase catalyst inventory cost unnecessarily.

The catalyst transport passage 121 may have a greater cross-sectional area at the central opening 121B of the plate 102 than at the catalyst outlet 120. In embodiments, catalyst transport passage 121 may be from 2 to than 6 times larger than the catalyst outlet 120, such as from 3.5 to 4.5 times larger. Accordingly, the cross sectional-area of the catalyst transport passage 121 may be from 2 to than 6 times larger at the central opening 121B of the plate 102 than at the catalyst outlet 120, such as from 3.5 to 4.5 times larger.

During operation. particulate solids, such as catalyst particulates, may be removed from the chemical processing vessel 110 via the catalyst transport passage 121. The catalyst transport passage 121 may be connected to a standpipe (not shown) to deliver the particulate solids to another vessel or processing unit. During operation, catalyst may be withdrawn from the vessel 110, and passed to the standpipe, at a catalyst flux of greater than or equal to 50 lb/ft²-sec to less than or equal to 400 1b/ft²-sec, such as from greater than or equal to 100 1b/ft²-sec to less than or equal to 300 1b/ft²-sec. The gaseous feed conduit 123 may deliver a gas into the chemical processing vessel 110 through the plate grid distributor 100 while the particulate solids may be removed via the catalyst transport passage 121. As such, the catalyst transition passage 121 forms a barrier between catalyst and gases that are eventually distributed.

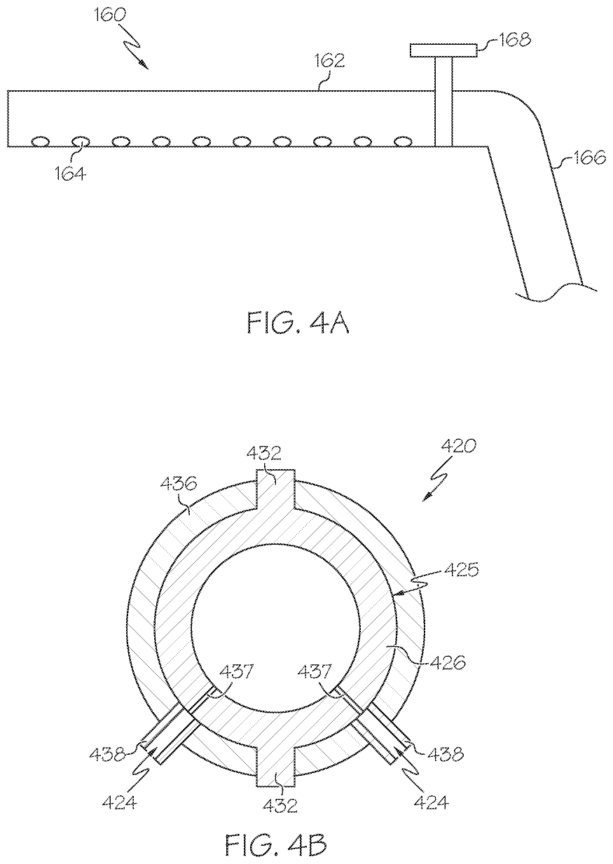

Referring now to FIGS. 1 and 4A-B. in embodiments, the chemical processing vessel 110 may include a sparger 160 above the plate 102 or within the catalyst transport passage 121 operable to direct a gas toward the catalyst outlet 120. The sparger may be utilized to fluidize materials passing through the catalyst transport passage 121 which, in some embodiments, may defluidize without use of a sparger due to the relatively large size of the catalyst transport passage 121. The sparger 160 may include a sparger body 162 and a plurality of sparger apertures 164. During operation, a fluid may be directed into the sparger body 162 and through the plurality of sparger apertures 164 to help fluidize particulate solids from the chemical processing vessel 110. The fluid may be directed downward toward the catalyst outlet 120 and may help fluidize the particulate solids from above the plate 102, through the catalyst transport passage 121, and out of the catalyst outlet 120. The fluid may be directed into the sparger body through a sparger feed pipe 166. The sparger 160 may deliver an oxygen-containing gas or an inert gas, such as nitrogen, into the chemical processing vessel 110. In embodiments, the chemical processing vessel 110 may include multiple spargers 160, such as two, three, five, or any number of spargers 160, and such spargers may be looped.

Referring to FIG. 4B. the sparger body 162 may comprise one or more sparger walls 426. The sparger 160 may include reinforcing bars 432 rigidly coupled to the outer surface of the sparger walls 426. Each of the plurality of sparger apertures 164 may comprise an orifice 437 at the start of each sparger aperture 164 to create pressure drop and create even distribution of the gas being fed through the sparger 160. The plurality of sparger apertures 164 may also include a diffuser 438 coupled to the sparger wall 426 at each of the sparger apertures 164. The diffusers 438 may slow the superficial gas velocity passing out of the orifices 437 to reduce or prevent catalyst attrition, damage to internal structures of the the chemical processing vessel 110, damage to the plate grid distributor 100, or damage to the catalyst transport passage 121.

Still referring to FIG. 4B. the sparger 160 may comprise a refractory material 436 lining the exterior of the sparger body 162 of the sparger 160. As used herein, a refractory material 136 is a material that may be resistant to decomposition by heat. pressure, or chemical attack, and may retain strength and form at high temperatures. Oxides of aluminum, silicon, magnesium, and calcium may be common materials used in the manufacturing of refractory materials.

Referring again to FIGS. 1 and 4A, the plate grid distributor 100 may comprise one or more loops 168. The one or more loops 168 may be fixed to the plate 102 using any conventional or yet-to-be developed means, such as welding. The one or more loops 168 may provide mechanical support to the sparger 160.

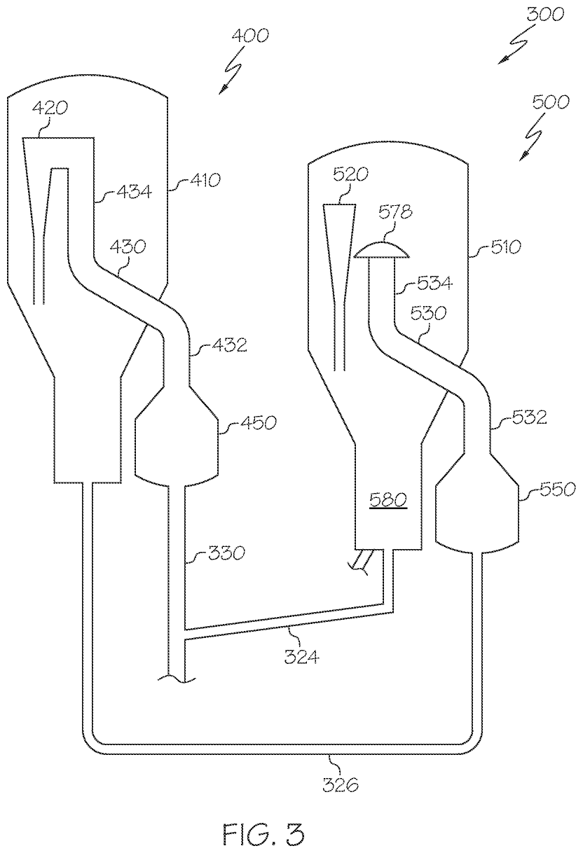

Now referring to FIG. 3. an example reactor system 300 in which the chemical processing vessels 110 of the present disclosure may be present is schematically depicted. The reactor system 200 generally comprises multiple system units, such as a reactor section 400 and a regenerator section 500. As used herein in the context of FIG. 3, a reactor section 400 generally refers to the portion of a reactor system 300 in which the major process reaction takes place, and the particulate solids are separated from the product stream of the reaction. In one or more embodiments, the particulate solids may be spent. meaning that they are at least partially deactivated. Also, as used herein, a regenerator section 500 generally refers to the portion of a reactor system 300 where the particulate solids are regenerated, such as through combustion, and the regenerated particulate solids are separated from the other process material, such as evolved gasses from the combusted material previously on the spent particulate solids or from supplemental fuel. The reactor section 400 generally includes a reaction vessel 450, a riser 430 including an exterior riser segment 432 and an interior riser segment 434, and a particulate solid separation section 410. The regenerator section 500 generally includes a particulate solid treatment vessel 550, a riser 530 including an exterior riser segment 532 and an interior riser segment 534, and a particulate solid separation section 510. Generally, the particulate solid separation section 410 may be in fluid communication with the particulate solid treatment vessel 550, for example, by standpipe 526, and the particulate solid separation section 510 may be in fluid communication with the reaction vessel 450, for example, by standpipe 324 and transport riser 330.

Generally, the reactor system 300 may be operated by feeding a hydrocarbon feed and fluidized particulate solids into the reaction vessel 450, and reacting the hydrocarbon feed by contact with fluidized particulate solids to produce a product in the reaction vessel 450 of the reactor section 400. The product and the particulate solids may be passed out of the reaction vessel 450 and through the riser 430 to a gas/solids separation device 420 in the particulate solid separation section 410, where the particulate solids may be separated from the product. The particulate solids may then be transported out of the particulate solid separation section 410 to the particulate solid treatment vessel 550. In the particulate solid treatment vessel 550, the particulate solids may be regenerated by chemical processes. For example, the spent particulate solids may be regenerated by one or more of oxidizing the particulate solid by contact with an oxygen containing gas, combusting coke present on the particulate solids, and combusting a supplemental fuel to heat the particulate solid. The particulate solids may then be passed out of the particulate solid treatment vessel 550 and through the riser 530 to a riser termination device 578, where the gas and particulate solids from the riser 530 are partially separated. The gas and remaining particulate solids from the riser 530 are transported to gas/solids separation device 520 in the particulate solid separation section 510 where the remaining particulate solids are separated from the gasses from the regeneration reaction. The particulate solids, separated from the gasses, may be passed to a solid particulate collection area 580, which may be structured as the plate grid distributors 100 of thechemical processing vessels 110 of the present disclosure (as further detailed in FIGS. 1-2). The separated particulate solids are then passed from the solid particulate collection area 580 to the reaction vessel 450, where they are further utilized. Thus, the particulate solids may cycle between the reactor section 400 and the regenerator section 500.

The solid particulate collection area 580 may also include an oxygen treatment zone. The oxygen treatment zone may be in fluid communication with reaction vessel 450 (e.g., via standpipe 324 and transport riser 330), which may supply processed catalyst from the catalyst processing portion 500 back to a reactor portion 400 of the reactor system 300. The oxygen treatment zone may include an oxygen-containing gas inlet 328, such as the gaseous feed conduit 123 of the plate grid distributors 100 of the present disclosure, which may supply an oxygen-containing gas to the oxygen treatment zone for oxygen treatment of the catalyst.

Referring again to FIG. 1. the present disclosure is also directed toward methods of operating a chemical processing vessel 110. The method may include passing a fluid into the chemical processing vessel 110 at reaction conditions through a gaseous feed conduit 123 below the plate grid distributor 100 and directing the fluid through a plate grid distributor 100 in the chemical processing vessel 110. The plate grid distributor 100 may include a plate 100 comprising an upper surface 104 and a lower surface 106 opposite the upper surface defining a thickness of the plate 100. The plate 100 may include a plurality of apertures 130 extending through the thickness of the plate 100. The plate 100 may include a central opening 121B. A catalyst transport passage 121 may extend from the central opening 121B to the catalyst outlet 120 forming a passage from an area above the plate 100 to the catalyst outlet 120. The catalyst transport passage 121 and the plate 100 may be connected such that they form a unitary body. The catalyst transport passage 121 may have a greater cross section area at the central opening 121B of the plate 100 than at the catalyst outlet 120. The method may include passing catalyst from above the plate 100. through the catalyst transport passage 121. and out of the chemical processing vessel 110 through the catalyst outlet 120.

The chemical processing vessel 110 may have any of the features previously discussed in this disclosure for the chemical processing vessel 110. The plate grid distributor 100 may have any of the features previously discussed in this disclosure for the plate grid distributor 100. The catalyst transport passage 121 may have any of the features previously discussed in this disclosure for the catalyst transport passage 121.

One or more aspect of the present disclosure are described herein. A first aspect may include a chemical processing vessel including side walls, a floor, a catalyst outlet through the floor, and a plate grid distributor for distributing a fluid in the chemical processing vessel. The plate grid distributor may include a plate comprising an upper surface and a lower surface opposite the upper surface defining a thickness of the plate. The plate may include a plurality of apertures extending through the thickness of the plate, and wherein the plate comprises a central opening. A catalyst transport passage may extend from the central opening to the catalyst outlet forming a passage from an area above the plate to the catalyst outlet. The catalyst transport passage and the plate may be connected such that they form a unitary body. The catalyst transport passage may have a greater cross section area at the central opening of the plate than at the catalyst outlet.

A second aspect of the present disclosure may include the first aspect, wherein the plate is substantially planar.

A third aspect of the present disclosure may include either the first or second aspect. wherein the plate comprises an average diameter of greater than or equal to 5 feet (1.5 m) to less than or equal to 75 feet (22.9 m).

A fourth aspect of the present disclosure may include any one of the first through third aspects. wherein the central opening is positioned in the center of the plate.

A fifth aspect of the present disclosure may include any one of the first through fourth aspects, wherein central opening from 2 to than 6 times larger than the catalyst outlet.

A sixth aspect of the present disclosure may include any one of the first through fifth aspects, wherein central opening is from 3.5 to 4.5 times larger than the catalyst outlet.

A seventh aspect of the present disclosure may include any one of the first through sixth aspects. further comprising an outer support extending downward from at or near the outer periphery of the plate.

An eighth aspect of the present disclosure may include the seventh aspect, wherein the outer support is angled.

A ninth aspect of the present disclosure may include any one of the first through eighth aspects. wherein the plate and catalyst transport passage are operable to contain catalyst below the plate inside the catalyst transport passage.

A tenth aspect of the present disclosure may include any one of the first through ninth aspects. wherein the catalyst transport passage comprise a fillet transition between the catalyst transport passage and the plate.

An eleventh aspect of the present disclosure may include any one of the first through tenth aspects. further comprising a refractory material in direct contact with and covering substantially all of the upper surface of the plate.

A twelfth aspect of the present disclosure may include any one of the first through eleventh aspects. further comprising a refractory material in direct contact with and covering substantially all of an inner surface of the catalyst transport passage.

A thirteenth aspect of the present disclosure may include any one of the first through twelfth aspects, further comprising a sparger within the catalyst transport passage operable to direct a gas toward the catalyst outlet.

A fourteenth aspect of the present disclosure may include any one of the first through thirteenth aspects, wherein the plurality of apertures comprise shrouds extending above the upper surface of the plate.

A fifteenth aspect of the present disclosure may include a method of operating a chemical processing vessel. The method may include passing a fluid into the chemical processing vessel at reaction conditions through a gaseous feed conduit below the plate grid distributor and directing the fluid through a plate grid distributor in the chemical processing vessel. The plate grid distributor may include a plate comprising a upper surface and a lower surface opposite the upper surface defining a thickness of the plate. The plate may include a plurality of apertures extending through the thickness of the plate. The plate may include a central opening. A catalyst transport passage may extend from the central opening to the catalyst outlet forming a passage from an area above the plate to the catalyst outlet. The catalyst transport passage and the plate may be connected such that they form a unitary body. The catalyst transport passage may have a greater cross section area at the central opening of the plate than at the catalyst outlet. The method may also include passing catalyst from above the plate. through the catalyst transport passage, and out of the chemical processing vessel through the catalyst outlet.

Finally, it will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A chemical processing vessel comprising:
side walls;
a floor;
a catalyst outlet through the floor; and
a plate grid distributor for distributing a fluid in the chemical processing vessel, the plate grid distributor comprising:
a plate comprising an upper surface and a lower surface opposite the upper surface defining a thickness of the plate, wherein the plate further comprises a plurality of apertures extending through the thickness of the plate, and wherein the plate comprises a central opening;
a catalyst transport passage extending from the central opening to the catalyst outlet forming a passage from an area above the plate to the catalyst outlet, wherein the catalyst transport passage and the plate are connected such that they form a unitary body, and wherein the catalyst transport passage has a greater cross-sectional area at the central opening of the plate than at the catalyst outlet.

2. The chemical processing vessel of claim 1, wherein the plate is substantially planar or dish shaped.

3. The chemical processing vessel of claim 1, wherein the plate comprises an average diameter of greater than or equal to 5 feet (1.5 m) to less than or equal to 75 feet (22.9 m).

4. The chemical processing vessel of claim 1, wherein the central opening is positioned in the center of the plate.

5. The chemical processing vessel of claim 1, wherein central opening from 2 to than 6 times larger than the catalyst outlet.

6. The chemical processing vessel of claim 1, wherein the catalyst transport passage comprises a conical frustum.

7. The chemical processing vessel of claim 1, further comprising an outer support extending downward from at or near the outer periphery of the plate.

8. The chemical processing vessel of claim 7, wherein the outer support is angled.

9. The chemical processing vessel of claim 1, wherein the plate and catalyst transport passage are operable to contain catalyst below the plate inside the catalyst transport passage.

10. The chemical processing vessel of claim 1, wherein the catalyst transport passage comprises a rounded transition between the catalyst transport passage and the plate.

11. The chemical processing vessel of claim 1, further comprising a refractory material in direct contact with and covering substantially all of the upper surface of the plate.

12. The chemical processing vessel of claim 1, further comprising a refractory material in direct contact with and covering substantially all of an inner surface of the catalyst transport passage.

13. The chemical processing vessel of claim 1, further comprising a sparger within the catalyst transport passage operable to direct a gas toward the catalyst outlet.

14. The chemical processing vessel of claim 1, wherein the plurality of apertures comprise shrouds extending above the upper surface of the plate.

15. A method of operating a chemical processing vessel, the method comprising:
passing a fluid into the chemical processing vessel at reaction conditions through a gaseous feed conduit below the plate grid distributor;
directing the fluid through a plate grid distributor in the chemical processing vessel, the plate grid distributor comprising:
a plate comprising a upper surface and a lower surface opposite the upper surface defining a thickness of the plate, wherein the plate further comprises a plurality of apertures extending through the thickness of the plate, and wherein the plate comprises a central opening;
a catalyst transport passage extending from the central opening to the catalyst outlet forming a passage from an area above the plate to the catalyst outlet, wherein the catalyst transport passage and the plate are connected such that they form a unitary body, and wherein the catalyst transport passage has a greater cross section area at the central opening of the plate than at the catalyst outlet; and
passing catalyst from above the plate, through the catalyst transport passage , and out of the chemical processing vessel through the catalyst outlet.
